(19) United States
(12) Patent Application Publication
(10) Pub. No.: US 2025/0339911 A1
(43) Pub. Date: Nov. 6, 2025

(54) SYSTEM AND METHOD FOR PERFORMING INTERNAL MACHINING

(71) Applicant: Siemens Energy, Inc., Orlando, FL (US)

(72) Inventors: Derrick Marcantel, Oviedo, FL (US); Forrest R. Ruhge, Orlando, FL (US); Eduardo Ramirez, Oviedo, FL (US)

(21) Appl. No.: 18/864,020

(22) PCT Filed: May 4, 2023
(86) PCT No.: PCT/US2023/066577

§ 371 Date: Nov. 8, 2024

Related U.S. Application Data
(60) Provisional application No. 63/350,896, filed on Jun. 10, 2022.

(51) Int. Cl. B23H 9/14; B23H 9/10; B23P 6/00

(52) U.S. Cl. CPC B23H 9/14; B23H 9/10; B23P 6/002

(57) ABSTRACT

A repair system for use in repairing a component includes an elongated repair tool having a first end that supports an electrode and a second end opposite the first end. A camera has a field of view and is fixedly attached to the elongated repair tool such that the electrode is within the field of view. A power supply is coupled to the electrode and is operable to deliver an electrical current to the electrode, the electrical current sufficient to form an arc between the electrode and the component to remove material from the component, where the second end of the elongated repair tool is movable to position the electrode in a desired position.

### BACKGROUND

The manufacture of complex parts sometimes requires the casting or forming of internal holes or passages. In some cases, these holes may not form properly or may become clogged with debris or unwanted material. If the location of these holes is not accessible, these casting flaws may result in the scrapping of the component.

### SUMMARY

In one aspect, a repair system for use in repairing a component includes an electrode conduit extending along a longitudinal axis and defining a first end and a second end. An electrode is attached to the first end of the electrode conduit and defines an electrode tip. A camera is connected to the electrode conduit proximate the first end and having a field of view that encompasses the electrode tip, a camera wire coupled to the camera and extends to the second end of the electrode conduit. The camera wire is operable to transmit a camera signal from the camera. A sheath is arranged to enclose a portion of the electrode conduit and a portion of the camera wire, and a power supply is operable to deliver an electrical current to the electrode tip, the electrical current is sufficient to form an arc between the electrode tip and the component to remove material from the component.

In another aspect, a repair system for use in repairing a component includes an elongated repair tool having a first end that supports an electrode and a second end opposite the first end. A camera has a field of view and is fixedly attached to the elongated repair tool such that the electrode is within the field of view. A power supply is coupled to the electrode and is operable to deliver an electrical current to the electrode, the electrical current sufficient to form an arc between the electrode and the component to remove material from the component, where the second end of the elongated repair tool is movable to position the electrode in a desired position.

In another aspect, a method of removing material from a component includes positioning a first end of an elongated repair tool within the component, the first end supporting an electrode and a camera having a field of view that encompasses the electrode, transmitting an image of the electrode from the camera, and manipulating a second end of the elongated repair tool based on the transmitted image to position the electrode in a desired position with respect to the component. The method also includes providing power to the electrode, the electrode producing an arc between the electrode and the component in response to receipt of the power, the arc operable to melt a portion of the component.

The foregoing has broadly outlined some of the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

To easily identify the discussion of any particular element or act, the most significant digit or digits in a reference number refer to the figure number in which that element is first introduced.

FIG. 1 illustrates a component that includes openings to an interior space.

FIG. 2 illustrates a repair system suitable for use in repairing features of the component of FIG. 1.

FIG. 3A illustrates a portion of the repair system of FIG. 2 positioned adjacent a clogged or improperly formed internal passage within the component of FIG. 1.

FIG. 3B illustrates a portion of the repair system of FIG. 2 positioned adjacent a clogged or improperly formed internal passage within the component of FIG. 1 with an open passage illustrated in the foreground.

FIG. 3C illustrates the passage of FIG. 3A following operation of the repair system.

FIG. 4A illustrates a portion of the repair system of FIG. 2 being positioned adjacent a clogged or improperly formed internal passage within the component of FIG. 1.

FIG. 4B illustrates the passage of FIG. 4A following the operation of the repair system.

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean that an element is relatively near to but not in contact with a further element or that the element is in contact with the further portion unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

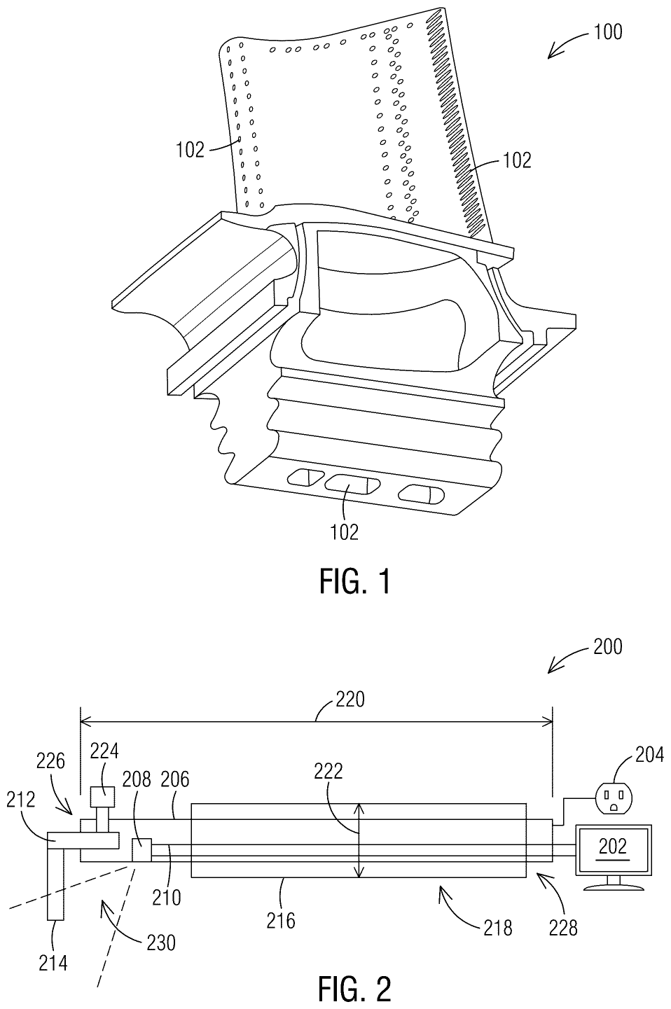

FIG. 1 illustrates a component 100 that can be manufactured using a number of different manufacturing processes including forging, casting, machining, additive manufacturing, and the like, or combinations thereof. The illustrated component 100 is a turbine blade such as a gas turbine blade for a large gas turbine. Often, turbine blades as well as other components 100 include internal features and passages that allow for internal flow or support. For example, the turbine blade illustrated in FIG. 1 may include multiple internal holes or passages that direct the flow of cooling air throughout the interior of the component 100. Multiple openings 102 are provided that lead into the interior of the component 100.

In some constructions, the turbine blade of FIG. 1 is formed using a casting process, an additive manufacturing process or a combination thereof. These processes can form holes or passages within the interior of the turbine blade but in some cases, the holes can be clogged or incompletely formed. In some cases, these defects cannot be repaired using conventional techniques which requires the scrapping of the turbine blade.

While FIG. 1 illustrates the component 100 in the form of a turbine blade, it will be clear that the system and method described herein are suitable for use with virtually any component 100 and in particular for components 100 that include small, enclosed spaces and passages that can become clogged. The turbine blade is but one example of a component 100 that is provided to facilitate the description of a repair system 200 and method.

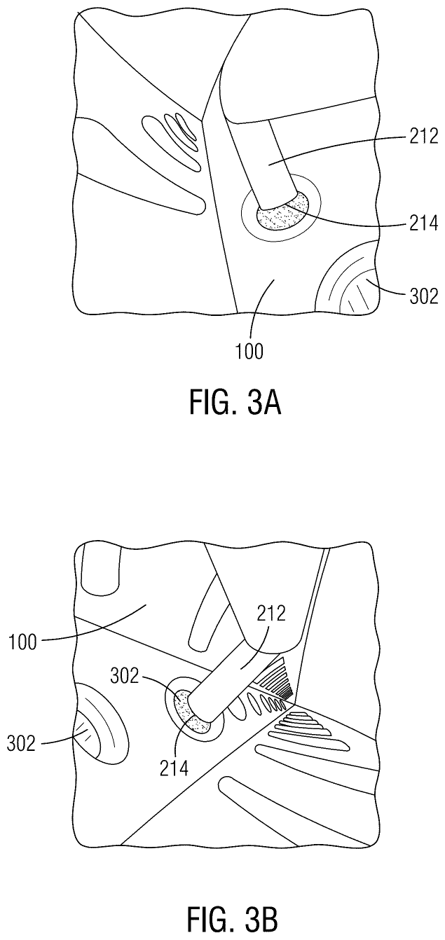

FIG. 2 illustrates a repair system 200 that is suitable for use in repairing components 100 such as the turbine blade of FIG. 1. In particular, the repair system 200 is well-suited to repairing incomplete or clogged holes or passages within the component 100 to reduce the scrap rate of the components 100.

The repair system 200 includes a monitor 202, a power supply 204, and an elongated repair tool 218 that defines an overall length 220 and a diameter 222. In most constructions, the elongated repair tool 218 has a length 220 that is at least 50 times greater than the diameter 222 with most applications including a length 220 that is between 50 and 1000 times the diameter 222.

The elongated repair tool 218 includes an electrode conduit 206 that extends between a first end 226 and a second end 228. An electrode 212 is attached to the first end 226 of the electrode conduit 206 and is fixed in a desired operating position using an electrode holder 224 in the form of a set screw. In the illustrated construction, the electrode 212 includes a ninety-degree bend such that an electrode tip 214 is spaced away from the electrode conduit 206. Of course, other constructions may include different arrangements of the electrode 212 including a straight electrode or an electrode with a bend other than ninety degrees. The electrode 212 and the electrode tip 214 may be any desired shape but in most constructions a circular cross-section or cylindrical shape is employed. In most constructions, the electrode 212 is formed from an electrically conductive material such as copper or graphite with other materials also being possible.

The electrode 212 is electrically connected to the electrode conduit 206 which in turn is electrically connected to the power supply 204 to allow for the delivery of electrical power from the power supply 204 to the electrode 212. The power supply 204 is arranged to deliver AC or DC power at the desired voltage and amperage as may be required for the particular application. The power supply 204 can be powered by any available electrical source including but not limited to 120 V or 240 V AC power.

A camera 208 is positioned at or near the first end 226 and defines a field of view 230 that allows the camera 208 to image at least the electrode tip 214 and the area immediately around the electrode tip 214. To achieve this, the camera 208 may be positioned at an angle (e.g., 45 degrees) with respect to the electrode conduit 206. In still other constructions, the camera 208 is movable to allow for adjustment and repositioning of the field of view 230.

A camera wire 210 connects to the camera 208 and operates to conduct a camera signal from the camera 208 to the monitor 202 where the images captured by the camera (video, still, black & white, color, infrared, etc.) can be displayed for a user. In other constructions, the monitor 202 is replaced or used in conjunction with a data storage device or a computer to otherwise capture and store data captured by the camera 208.

A sheath 216 is positioned between the first end 226 and the second end 228 such that it surrounds and covers a portion of the electrode conduit 206 as well as a portion of the camera wire 210. The sheath 216 is flexible and provides some protection for the electrode conduit 206 and the camera wire 210 disposed therein. In addition, the sheath 216 is an electrical insulator that reduces the likelihood of unwanted contact and shorts between the electrode conduit 206 and the component 100 during positioning or use of the repair system 200.

The sheath 216, the electrode conduit 206, and the camera wire 210 are flexible enough that a user is able to manipulate the second end 228 of the elongated repair tool 218 to position the electrode 212 and more importantly the electrode tip 214 in a desired position. The camera 208 captures images (video or still) of the electrode 212 and the electrode tip 214 as well as the surrounding area. These images may be presented on the monitor 202 to assist the user in positioning the electrode tip 214 in the desired position.

Once the electrode tip 214 is positioned as desired, the user initiates operation of the power supply 204 to deliver electrical power to the electrode 212. The power, in the form of a voltage and a current forms an arc between the electrode tip 214 and the component 100 in the area near the electrode tip 214. The current and voltage are sufficient to quickly melt the material that makes-up the component 100 in the area adjacent the electrode tip 214. In contrast, the electrode 212 is formed from a highly conductive material (e.g., copper) and/or a high melting point material (e.g., graphite) such that the electrode tip 214 does not melt and is therefore not consumed. The repair system 200 operates as an electrical discharge machining (EDM) system that can be used to remove small amounts of material of the component 100. In particular, the repair system 200 is capable of positioning the electrode tip 214 within the component 100 by passing it through one of the openings 102 or another opening and into positions not accessible by conventional tools. The power supply 204 then provides sufficient power to melt any unwanted material that may be positioned within a passage or hole to melt and remove that material, thereby allowing for the repair of components 100 that may otherwise need to be scrapped.

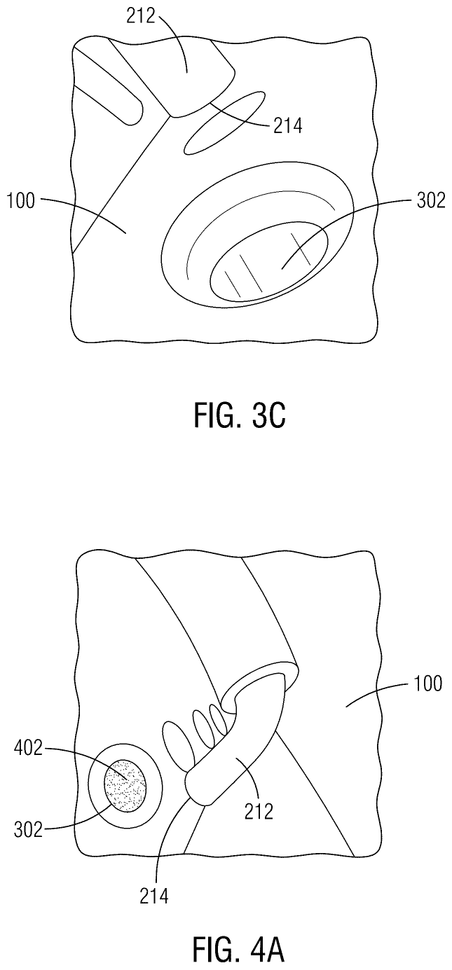

FIG. 3A through FIG. 3C illustrate a process of opening an interior passage 302 within the component 100 that is clogged or partially filled with an obstruction. During a casting process, it is possible for debris or unwanted material to obstruct or partially obstruct small interior passages 302. With reference to FIG. 3A, the electrode 212 and the electrode tip 214 are positioned in the desired location within the component 100 and adjacent an area where one of the interior passages 302 should have been formed.

Turning to FIG. 3B, the electrode 212 is positioned within a narrow channel within the component 100 and is oriented such that the electrode tip 214 is directly adjacent a location where one of the interior passages 302 should have been formed. In this position, when the power supply 204 is activated, an arc will form between the electrode tip 214 and the unwanted material within the interior passage 302, thereby melting and removing the unwanted material and opening the interior passage 302.

FIG. 3C better illustrates the interior passage 302 following the removal of the unwanted material.

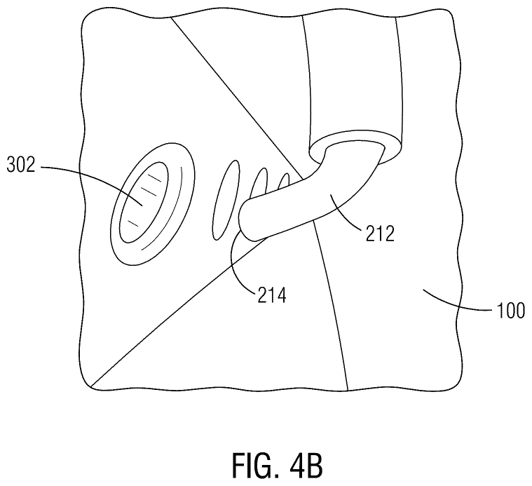

FIG. 4A is another example of a use for the repair system 200 of FIG. 2. In this example, the electrode 212 is positioned within a narrow channel that is formed within the component 100. The second end 228 of the elongated repair tool 218 is manipulated to position the electrode tip 214 adjacent an amount of unwanted material 402 that is inside and obstructing an interior passage 302. As can be seen, the interior passage 302 is one of a series of interior passages 302 that extends along the length of the channel. Without the repair system 200, a blockage or obstruction such as the unwanted material 402 in the interior passage 302 might lead to the scrapping of the component 100.

FIG. 4B illustrates the interior passage 302 after the activation of the power supply and the removal of the unwanted material 402. As described, the repair system 200 operates as an EDM system to produce an arc that melts the unwanted material 402 to open the interior passage 302 thereby avoiding the need to scrap the component 100.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A repair system for use in repairing a component, the repair system comprising:
an electrode conduit extending along a longitudinal axis and defining a first end and a second end, the first end positionable within a cavity of the component;
an electrode attached to the first end of the electrode conduit, the electrode defining an electrode tip;
a camera connected to the electrode conduit proximate the first end and having a field of view that encompasses the electrode tip;
a camera wire coupled to the camera and extending to the second end of the electrode conduit, the camera wire operable to transmit a camera signal from the camera;
a sheath arranged to enclose a portion of the electrode conduit and a portion of the camera wire; and
a power supply operable to deliver an electrical current to the electrode tip, the electrical current sufficient to form an arc between the electrode tip and the component to remove material from the component.

2. The repair system of claim 1, wherein the electrode conduit defines a diameter and a length in the longitudinal direction, and wherein the length is between 50 and 1000 times the diameter.

3. The repair system of claim 1, wherein the camera is fixedly attached to the electrode conduit.

4. The repair system of claim 1, wherein the electrode conduit, the electrode, and the sheath cooperate to at least partially define an elongated repair tool having a working end that corresponds to the first end of the electrode conduit and a manipulation end that corresponds to the second end of the electrode conduit.

5. The repair system of claim 4, wherein movement of the manipulation end produces a corresponding movement of the working end and the electrode tip.

6. The repair system of claim 1, wherein the power supply and the electrode tip cooperate to perform an electrical discharge machining (EDM) operation.

7. The repair system of claim 1, wherein the component is formed using one of a casting process and an additive manufacturing process.

8. A repair system for use in repairing a component, the repair system comprising:
an elongated repair tool having a first end that supports an electrode and a second end opposite the first end, the electrode sized to fit within an internal cavity formed in the component;
a camera having a field of view, the camera fixedly attached to the elongated repair tool such that the electrode is within the field of view; and
a power supply coupled to the electrode and operable to deliver an electrical current to the electrode, the electrical current sufficient to form an arc between the electrode and the component to remove material from the component, wherein the second end of the elongated repair tool is movable to position the electrode in a desired position.

9. The repair system of claim 1, wherein the elongated repair tool defines a diameter and a length in a longitudinal direction, and wherein the length is between 50 and 1000 times the diameter,

10. The repair system of claim 1, wherein the elongated repair tool includes an electrode conduit, the electrode, and a sheath that surrounds a portion of the electrode conduit.

11. The repair system of claim 1, wherein the power supply and the electrode cooperate to perform an electrical discharge machining (EDM) operation.

12. The repair system of claim 1, wherein the component is formed using one of a casting process and an additive manufacturing process.

13. A method of removing material from a component, the method comprising:
positioning a first end of an elongated repair tool within the component, the first end supporting an electrode and a camera having a field of view that encompasses the electrode;
transmitting an image of the electrode from the camera;
manipulating a second end of the elongated repair tool based on the transmitted image to position the electrode in a desired position with respect to the component; and
providing power to the electrode, the electrode producing an arc between the electrode and the component in response to receipt of the power, the arc operable to melt a portion of the component.

14. The method of claim 13, wherein the elongated repair tool is operable to perform an electrical discharge machining (EDM) operation.

15. The method of claim 13, further comprising forming the component using a casting process.

16. The method of claim 13, further comprising forming the component using an additive manufacturing process.
